(19) United States
(12) Patent Application Publication
(10) Pub. No.: US 2015/0055551 A1
(43) Pub. Date: Feb. 26, 2015

(54) MOBILE WIRELESS ACCESS POINT NOTIFICATION DELIVERY FOR PERIODICALLY DISCONNECTED MOBILE DEVICES

(71) Applicant: International Business Machines Corporation, Armonk, NY (US)

(72) Inventors: Eric J. Burckart, Raleigh, NC (US); Dinakaran Joseph, Apex, NC (US); Todd E. Kaplinger, Raleigh, NC (US); Victor S. Moore, Lake City, FL (US); Gregory L. Truty, Austin, TX (US)

(73) Assignee: International Business Machines Corporation, Armonk, NY (US)

(21) Appl. No.: 14/010,127

(22) Filed: Aug. 26, 2013

(51) Int. Cl. H04L 12/947; H04W 40/24

(52) U.S. Cl. CPC H04L 49/252; H04W 40/248
USPC 370/328

(57) ABSTRACT

A mobile wireless access point includes at least one processor, memory and a cellular radio disposed within a housing, as well as a wireless router configured to generate and maintain a wireless hotspot within a geographic distance of the housing and to route data from the wireless hotspot to the Internet over the broadband data connection. Finally, the mobile wireless access point includes a mobile wireless access point notification delivery module executing in the memory of the housing and programmed to respond to a determination that a mobile device formerly connected to the wireless hotspot no longer is connected to the wireless hotspot by queuing in the memory messages received from over the broadband connection that are directed to the mobile device, and by subsequently delivering the queued messages to the mobile device in response to a determination that the mobile device has reconnected to the wireless hotspot.

### BACKGROUND OF THE INVENTION

1. Field of the Invention

The present invention relates to offline computing for mobile devices and more particularly to notification delivery to periodically disconnected mobile devices.

2. Description of the Related Art

Mobile devices have emerged from mere telephonic communicators to full-fledged portable computing platforms. Originally, designed as a mere merger of a personal digital assistant and a cellular telephone, the modern mobile device integrates the functionality of cellular telephony and data communications so as to provide advanced modes of communication and computing. In particular, the integration of the functionality of cellular telephony and data communications now permits true remote computing utilizing mobile devices as end user clients accessing applications over the Internet.

Of note, unlike a personal computer fixed in an office environment which enjoys continuous network connectivity, mobile devices frequently lose data connectivity during cellular telephony. Further, mobile devices lose data connectivity when removed from a wireless networking environment, or when the mobile devices travel outside of range of cellular or broadband data connectivity. Yet, some applications utilizing mobile devices as end user clients permit continued computing with changes in application data synchronized once data connectivity becomes re-established. The process of synchronization generally involves a comparison of changed records at a remote server and within the mobile device to identify records to be updated at both ends.

Further, during periods when a mobile device does not enjoy data connectivity, the remote server queues undelivered notifications intended for delivery to the mobile device in an arrangement commonly referred to as “store and forward”. In store and forward, the remote server periodically re-attempts delivery of the notifications to the mobile device until the mobile device regains connectivity in order to receive the queued notifications. Depending upon the length of time of during which the mobile device remains disconnected, a substantial number of events may have occurred resulting in the undesirable clogging both of the queue in the remote server, as well as network bandwidth resulting from multiple delivery attempts of the notifications by the remote server.

### BRIEF SUMMARY OF THE INVENTION

Embodiments of the present invention address deficiencies of the art in respect to notification delivery to mobile devices and provide a novel and non-obvious method, system and computer program product for mobile wireless access point notification delivery for periodically disconnected mobile devices. In an embodiment of the invention, a method for mobile wireless access point notification delivery for periodically disconnected mobile devices is provided. The method includes providing in a wireless access point, a wireless hotspot for different mobile devices and establishing a cellular communications link between the wireless access point and the Internet. The method also includes routing messages between the mobile devices and the cellular communications link through the wireless hotspot. Finally, the method includes identifying a mobile device no longer connected to the wireless hotspot and in response, queuing messages in the wireless access point received from the Internet and directed to the identified mobile device. Subsequently, responsive to a determination that the identified mobile device has reconnected to the wireless hotspot, the method includes delivering the queued messages to the identified mobile device.

In another embodiment of the invention, a mobile wireless access point is provided. The mobile wireless access point includes at least one processor, memory and a cellular radio disposed within a housing, the cellular radio providing a broadband data connection to the Internet. The mobile wireless access point also includes a wireless router coupled to the processor, memory and cellular radio within the housing and configured to generate and maintain a wireless hotspot within a geographic distance of the housing and to route data from the wireless hotspot to the Internet over the broadband data connection. Finally, the mobile wireless access point includes a mobile wireless access point notification delivery module executing in the memory of the housing. The module includes program code enabled upon execution by the at least one processor in the housing to respond to a determination that a mobile device formerly connected to the wireless hotspot no longer is connected to the wireless hotspot by queuing in the memory messages received from the Internet over the broadband connection that are directed to the mobile device, and by subsequently delivering the queued messages to the mobile device in response to a determination that the mobile device has reconnected to the wireless hotspot.

In one aspect of the embodiment, the program code of the module is further enabled to respond to a determination that a remote server endpoint receiving messages from the mobile device no longer is accessible over the cellular communications network by queuing messages in the memory that are received from the mobile device and that are directed to the remote server endpoint, and by subsequently delivering the queued messages to the previously inaccessible remote server in response to a determination that the remote server endpoint has become accessible. Finally, in another aspect of the embodiment, the program code of the module is further enabled to optimize the queued messages for the remote server endpoint before delivering the queued messages to the remote server endpoint.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a computing architecture configured for mobile wireless access point notification delivery for periodically disconnected mobile devices; and,

FIG. 2 is a flow chart illustrating a process for mobile wireless access point notification delivery for periodically disconnected mobile devices.

### DETAILED DESCRIPTION OF THE INVENTION

Embodiments of the invention provide for mobile wireless access point notification delivery for periodically disconnected mobile devices. In accordance with an embodiment of the invention, a mobile wireless access point can establish a cellular data connection with a remote server over both a cellular communications network and the Internet. Also, the mobile wireless access point can establish a wireless data communications link with one or more mobile devices. Thereafter, the mobile wireless access point can act as a proxy to either or both of the cellular communications network and the mobile devices. Specifically, when a mobile device becomes disconnected from the access point, messages directed to the mobile device can be received in the access point and queued for delivery to the mobile device once the mobile device reconnects to the access point.

Conversely, messages can be received in the access point from the mobile device and routed as directed to a remote server endpoint through the cellular data connection. However, when data connectivity is lost as between the remote server endpoint and the wireless access point the wireless access point can continue to receive and subsequently queue the received messages from the mobile device. Once data connectivity resumes as between the wireless access point and the remote server endpoint, the wireless access point can deliver the queued messages to the remote server endpoint. In this way the loss of connectivity with the server endpoint need not inhibit the mobile devices from sending messages, and the loss of connectivity with the mobile devices need not inhibit the receipt of messages for the mobile devices so as to overburden the cellular communications network.

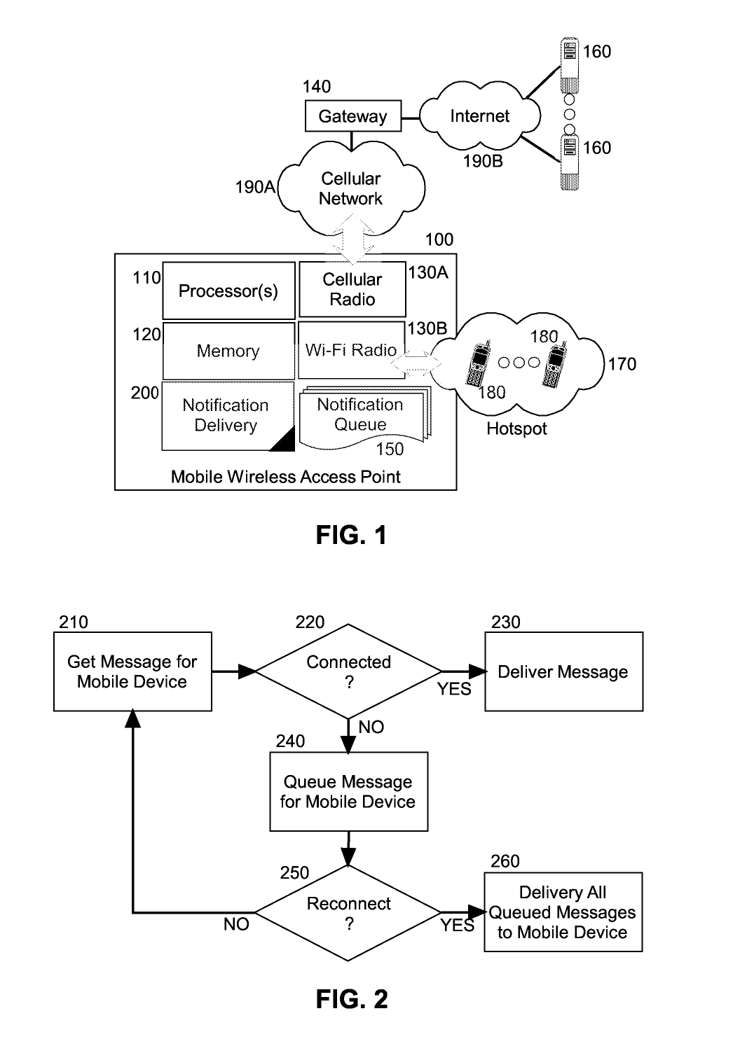

In further illustration, FIG. 1 pictorially shows a computing architecture configured for mobile wireless access point notification delivery for periodically disconnected mobile devices. As shown in FIG. 1, a mobile wireless access point 100 can include a housing enclosing at least one processor 110, memory 120, a cellular radio 130A and a wireless networking radio 130B. The cellular radio 130A can be configured to establish and maintain a cellular telephonic connection to a cellular network 190A and to process data communications therethrough from the mobile wireless access point 100 to one or more remote endpoint servers 160 disposed about the Internet 190B, by way of a network gateway 140.

The wireless networking radio 130B in turn can be configured to establish and maintain a wireless hotspot 170 within a limited geographic distance of the mobile wireless access point 100. Within the hotspot 170, short range wireless data communications can be managed between coupled computing devices 180, for example laptop computers, personal computers, personal digital assistants, tablet computers, smartphones and the like. Further, within the hotspot 170, data communications can be managed between individual ones of the computing devices 180 and the remote endpoint servers 160 through the cellular network 190A and the Internet 190B.

Of note, a notification delivery module 200 can be disposed within the mobile wireless access point 100, for example within firmware or other persistent memory of the mobile wireless access point 100. The module 200 can include program code that when loaded into memory 120 and executed by the processor(s) 110 is enabled to act as a proxy to either or both of the cellular communications network 190A and the computing devices 180. Specifically, when the program code determines that one of the computing devices 180 has become disconnected from the mobile wireless access point 100 by way of the hotspot 170 provided thereby, messages directed to the one of the computing devices 180 received in the mobile wireless access point 100 can be queued in notification queue 150 for delivery to the one of the computing devices 180 once the program code detects the reconnection of the one of the computing devices 180 to the mobile wireless access point 100 by way of the hotspot 170.

Conversely, the program code of the notification delivery module 200 can be enabled to detect when data connectivity is lost as between one of the remote server endpoints 160 communicating with one of the computing devices 180. In response, the program code can be enabled to queue messages in the notification queue 150 received from the one of the computing devices 180. Thereafter, upon the program code detecting that data connectivity has resumed as between the wireless access point 100 and the one of the remote server endpoints 160, the program code can be enabled to deliver the queued messages to the one of the remote server endpoints 160.

Optionally, prior to delivering the queued messages to the one of the remote server endpoints 160, the queued messages can be optimized, for example consolidated to reduce redundancies in messages. For instance, the queued messages can be organized based upon characteristics of the queued messages including destination target for the messages, e.g. whether or not the target is for a single end user or a group of end users, the identify of a push notification provider of the messages or the type of the sending or target device. In addition, in the instance where the recipient device or recipient provider of the message can receive customized payloads, the messages can be further optimized by performing data compression upon the messages intended for devices or providers able to handle the customized payloads.

In yet further illustration, FIG. 2 is a flow chart depicting a process for mobile wireless access point notification delivery for periodically disconnected mobile devices. The process can begin in block 210 with the receipt of a message from over the Internet directed to a mobile device coupled to the mobile wireless access point by way of a hotspot provided and maintained by the mobile wireless access point. In decision block 220, it can be determined whether or not the mobile device remains connected to the mobile wireless access point by way of the hotspot. If so, the message can be delivered to the mobile device in block 230.

In decision block 220, if it is determined that the mobile device is not connected to the mobile wireless access point by way of the hotspot, in block 240 the message can be placed in a notification queue instead of routing the message to the mobile device. Thereafter, in decision block 250 it can be determined whether or not the mobile device has reconnected to the mobile wireless access point by way of the hotspot. If in decision block 250 it is determined that the mobile device has reconnected to the mobile wireless access point by way of the hotspot, in block 260 all messages queued for the mobile device can be delivered to the mobile device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for mobile wireless access point notification delivery for periodically disconnected mobile devices, the method comprising:
providing in a wireless access point, a wireless hotspot for a plurality of different mobile devices;
establishing a cellular communications link between the wireless access point and the Internet;
routing messages between the mobile devices and the cellular communications link through the wireless hotspot; and,
responsive to identifying a mobile device no longer connected to the wireless hotspot, queuing messages in the wireless access point received from the Internet and directed to the identified mobile device, and responsive to a determination that the identified mobile device has reconnected to the wireless hotspot, delivering the queued messages to the identified mobile device.

2. The method of claim 1, further comprising determining that a remote server endpoint in the Internet receiving messages from the mobile devices is no longer accessible from over the cellular communications network, and responding to the determination by queuing messages in the wireless access point that are received from the mobile devices and that are directed to the remote server endpoint, and responding to a subsequent determination that the remote server endpoint has become accessible after having been inaccessible by delivering the queued messages to the remote server endpoint.

3. The method of claim 2, further comprising optimizing the queued messages for the remote server endpoint before delivering the queued messages to the remote server endpoint.

4. A mobile wireless access point comprising:
at least one processor, memory and a cellular radio disposed within a housing, the cellular radio providing a broadband data connection to the Internet;
a wireless router coupled to the processor, memory and cellular radio within the housing and configured to generate and maintain a wireless hotspot within a geographic distance of the housing and to route data from the wireless hotspot to the Internet over the broadband data connection; and,
a mobile wireless access point notification delivery module executing in the memory of the housing, the module comprising program code enabled upon execution by the at least one processor in the housing to respond to a determination that a mobile device formerly connected to the wireless hotspot no longer is connected to the wireless hotspot by queuing in the memory messages received from the Internet over the broadband connection that are directed to the mobile device, and by subsequently delivering the queued messages to the mobile device in response to a determination that the mobile device has reconnected to the wireless hotspot.

5. The mobile wireless access point of claim 4, wherein the program code of the module is further enabled to respond to a determination that a remote server endpoint receiving messages from the mobile device no longer is accessible over the cellular communications network by queuing messages in the memory that are received from the mobile device and that are directed to the remote server endpoint, and by subsequently delivering the queued messages to the previously inaccessible remote server in response to a determination that the remote server endpoint has become accessible.

6. The mobile wireless access point of claim 5, wherein the program code of the module is further enabled to optimize the queued messages for the remote server endpoint before delivering the queued messages to the remote server endpoint.
